(19) United States
(12) Patent Application Publication
(10) Pub. No.: US 2010/0127512 A1
(43) Pub. Date: May 27, 2010

(54) VEHICLE DOOR LATCH

(75) Inventors: Francisco J. Vazquez, Cd. Juarez Chihuahua (MX); Alfredo Martinez, Cd. Juarez Chihuahua (MX); Moises Alcala, Cd. Juarez Chihuahua (MX)

Correspondence Address: CANTOR COLBURN, LLP, 20 Church Street, 22nd Floor, Hartford, CT, 06103, US

(73) Assignee: INTEVA PRODUCTS LLP, Troy, MI (US)

(21) Appl. No.: 12/324,103

(22) Filed: Nov. 26, 2008

(51) Int. Cl. E05C 3/00

(52) U.S. Cl. 292/216

(57) ABSTRACT

A door latch comprising a forkbolt that has a movement between a latched position and an unlatched position is provided. A detent is included that has movement on a travel path between a first position and a second position, the detent engaging and holding the forkbolt in the latched position when the detent is in the first position. The detent releases the forkbolt for movement to the unlatched position when the detent moves to the second position. A detent spring eccentrically engages the detent relative to the detent travel path and biases the detent toward the first position. A release mechanism is also included for moving the detent against the bias of the detent spring to the second position, thus releasing the forkbolt and producing a non-linear torque on the detent.

### BACKGROUND OF THE INVENTION

An automotive closure, such as a door for an automobile passenger compartment, is hinged to swing between open and closed positions and conventionally includes a door latch that is housed between inner and outer panels of the door. The door latch functions in a well known manner to latch the door when it is closed and to lock the door in the closed position or to unlock and unlatch the door so that the door can be opened manually.

In general terms, the door latch has a forkbolt that engages a striker in the door jamb to latch the door when it is closed and a spring biased detent lever that engages and holds the forkbolt in the latched position. The door latch also typically has a release mechanism for moving the detent to a position releasing the forkbolt so that the door can be unlatched and opened and a lock mechanism for disabling the release mechanism to prevent unauthorized unlatching of the door. U.S. Pat. No. 6,053,543 granted to Frank Joseph Arabia, Jr. et al. Apr. 25, 2000, which is incorporated by reference herein, shows a typical door latch, including a latch and release mechanism, as known in the prior art.

Since the point of contact of the spring and the pivot is constant, the torque created by movement of the detent increases linearly as a function of the spring deformation. As a result the force to disengage the forkbolt from the striker is greatest at the end of travel and the lowest at initial engagement.

### SUMMARY OF THE INVENTION

The present invention allows the torque required to disengage the forkbolt to be variable, relative to the travel of the detent. In one embodiment, the invention allows the force vector to change direction by placing a detent spring eccentric to a detent lever travel path. Thus, detent torque varies over the path of detent travel.

According to one aspect of the invention, a door latch comprising a forkbolt that has a movement between a latched position and an unlatched position is provided. A detent is included that has movement on a travel path between a first position and a second position, the detent engaging and holding the forkbolt in the latched position when the detent is in the first position. The detent releases the forkbolt for movement to the unlatched position when the detent moves to the second position. A detent spring eccentrically engages the detent relative to the detent travel path and biases the detent toward the first position. A release mechanism is also included for moving the detent against the bias of the detent spring to the second position, thus releasing the forkbolt and producing a non-linear torque on the detent.

According to another aspect of the invention, a door latch comprising a forkbolt that has a movement between a latched position and an unlatched position is provided. The latch includes a detent that has movement along a travel path between a first position and a second position, the detent engaging and holding the forkbolt in the latched position when the detent is in the first position, the detent releasing the forkbolt for movement to the unlatched position when the detent is in the second position. A detent spring biases the detent toward the first position. An unlatching lever pivotably engages the detent for moving the detent against the bias of the detent spring to the second position to release the forkbolt, the detent spring eccentrically engaging the detent relative to the travel path.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a partial front view of a vehicle door latch, in a latched position, in accordance with the present invention;

FIG. 2 is a partial front view of the vehicle door latch of FIG. 1, in an unlatched position, in accordance with the present invention;

FIG. 3 is a rear pictorial view of the vehicle door latch, in a latched position, in accordance with the present invention;

FIG. 4 is a rear pictorial view of the vehicle door latch of FIG. 3, in an unlatched position, in accordance with the present invention; and

FIG. 5 is a graph showing the torque imparted to the latch in accordance with the present invention.

### DETAILED DESCRIPTION OF THE INVENTION

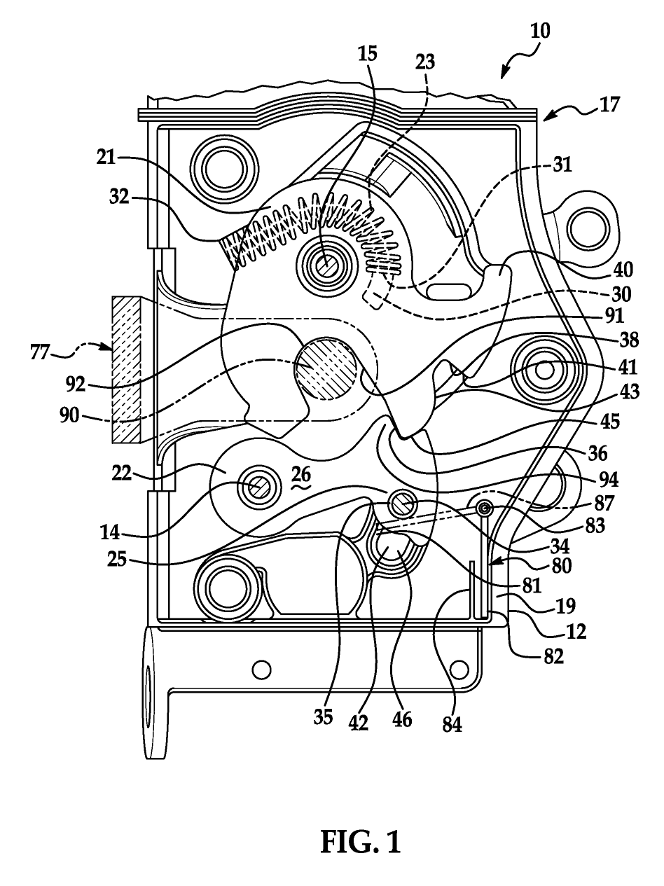

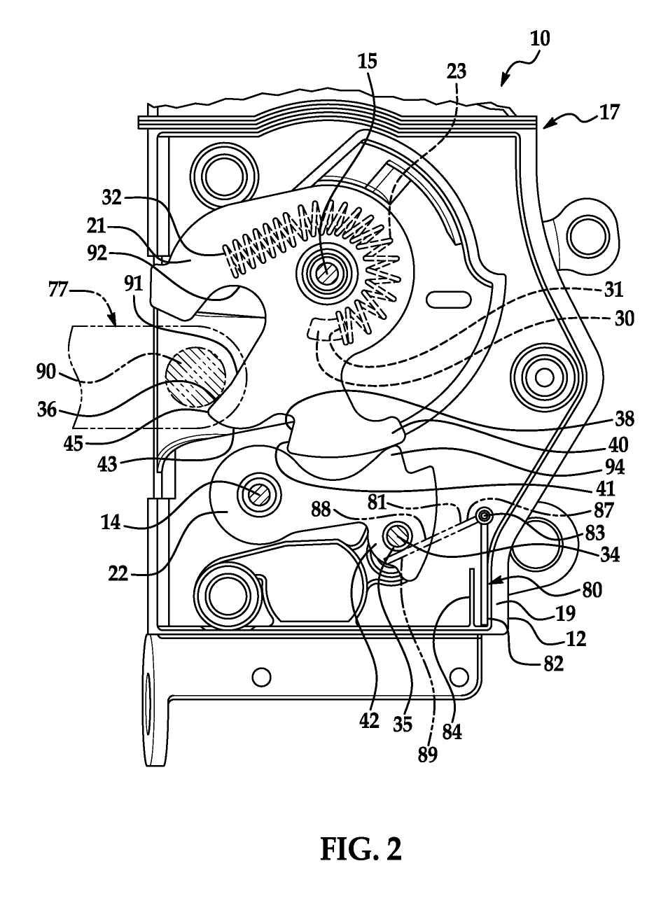

Referring now to FIGS. 1 and 2, where the invention will be described with reference to specific embodiments, without limiting same, a vehicle door latch 10 has a multi-piece enclosure that comprises a housing 12, a metal frame or face plate (not shown) and a back cover (not shown). The housing 12 and the metal face plate are held together by two flanged studs 14 and 15 that are inserted through two holes in the housing 12, through two aligned holes in the metal face plate and thereafter flanged over the metal face plate to form a forward compartment 17 of door latch 10.

Door latch 10 has a latch mechanism comprising a forkbolt 21 and a cooperating detent 22 that are located in the forward compartment 17 and pivotally mounted on the forward portions of studs 15 and 14, respectively. Forkbolt 21 is biased clockwise by a compression spring 23 that is disposed in a curved slot (not shown) in housing 12 behind forkbolt 21. Spring 23 engages a lateral lug 30 of forkbolt 21 at a first end 31 and an end wall (not shown) of the curved slot at a second end 32.

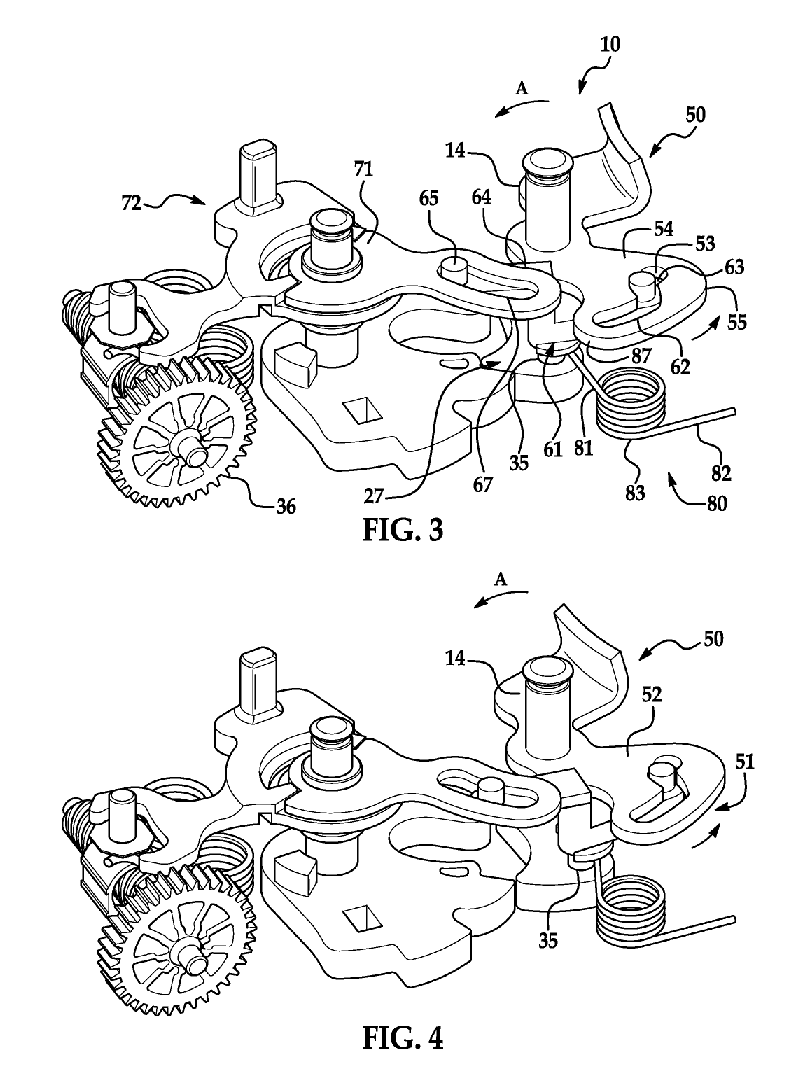

Detent 22 engages a lateral pin 34 through an opening 25 within the detent 22 that extends between a first side 26 and a second side 27 of the detent. Lateral pin 34 is rotatable within opening 25 and extends through a housing slot 42 that defines a travel path 46 for lateral pin 34 and into a rear compartment 50. Rear compartment 50, best seen in FIGS. 3 and 4, is formed by housing 12 and the back cover, both of which have been removed from the views shown in FIGS. 3 and 4 for clarity. Door latch 10 has a release mechanism 51 for releasing or unlatching the latching mechanism that is disposed in the rear compartment 50.

Details of the release mechanism 51 are shown in FIGS. 3 and 4. Specifically, an unlatching lever 52 is shown retained on first stud 14 and being adapted to rotate thereabout, as shown by the arrow A in FIGS. 3 and 4. Unlatching lever 52 has an intermittent lever slot 53 extending between rear side 54 and front side 55 of the unlatching lever 52. Retained within intermittent lever slot 53 and pivotably engaging unlatching lever 52 is an intermittent lever 61. An intermediate portion of intermittent lever 61 includes lateral pin 34. Extending therefrom is a first arm portion 62 having a first lever pivot 63 that pivotably engages intermittent lever slot 53. A second arm portion 64 also extends from lateral pin 34. Extending from second arm portion 64 is a second lever pivot 65 that pivotably engages a slot 67 within a locking lever 71 of a three-piece locking mechanism 72. Locking lever 71, being rotatable about second stud 15, causes door latch 10 to be placed in a locked or unlocked position in a known manner and will not be described in further detail herein.

As can be seen from FIGS. 1 and 3 showing door latch 10 in a latched position and FIGS. 2 and 4 showing door latch 10 in an unlatched position, detent 22 is rotated clockwise from the latched position shown in FIGS. 1 and 3 and out of latched engagement with the forkbolt 21 to a release or unlatched position shown in FIGS. 2 and 4 when the latching mechanism is operated. This releases forkbolt 21 so that it is free to rotate clockwise from the latched position shown in FIG. 1 to the unlatched position shown in FIG. 2 under the bias of a detent spring 80 when the vehicle door is opened. The locking mechanism 72 of door latch 10 disables the release mechanism 51 located in rear compartment 50 defined by housing 12 and the back cover, in a conventional manner.

Detent 22 is biased counterclockwise into engagement with forkbolt 21 by the detent spring 80, shown as a torsion spring, that engages an outer circumferential surface 35 of lateral pin 34. Specifically, in the exemplary embodiment shown, detent spring 80 includes a first finger 81, a second finger 82 and a central helical portion 83. Detent spring 80 is held in place at a slot 84 adjacent a lateral edge portion 19 of housing 12. Second finger 82 rests in slot 84 and bears against lateral edge portion 19 when detent spring 80 is under compression. It will be appreciated that detent spring 80 may alternatively be held in place by any number of known methods, including a pin extending from the back cover of housing 12, over which central helical portion 83 rests.

Detent 22 engages forkbolt 21 at a primary latch shoulder 36 and holds forkbolt 21 in a primary latched position against the bias of detent spring 80, as shown in FIG. 1. Detent 22 engages forkbolt 21 at a foot 40 in its unlatched or release position as shown in FIGS. 2 and 4. Detent spring 80 is in contact with lateral pin 34 at all times, and thus, in compression to prevent rattle and wear, including in the primary latched position of FIGS. 1 and 3.

As described now in detail, and as shown in FIGS. 1 and 3, in the latched position, outer circumferential surface 35 of lateral pin 34 is in contact with detent spring 80 at first finger 81 at a first portion 87 adjacent central helical portion 83. When it is desired to unlatch door latch 10, unlatching lever 52 is moved in the direction of arrow A, in FIG. 3, causing unlatching lever to rotate about first stud 14. Thereafter, intermittent lever slot 53 captures first lever pivot 63 on first arm portion 62, causing intermittent lever 61 and lateral pin 34 to push against the bias of first finger 81 of detent spring 80 and lateral pin 34 to move within housing slot 42 along travel path 46.

As lateral pin 34 moves in the arc of housing slot 42 that is travel path 46, the outer circumferential surface 35 of pin 34 slides along the first finger 81 from first portion 87 to a second portion 88, adjacent an end 89 of first finger 81 and opposite central helical portion 83. As lateral pin 34 is engaged through opening 25 of the detent 22, detent 22 rotates about first stud 14 causing a catch 94 of detent 22 to move out of the engagement with primary latch shoulder 36 of forkbolt 21. Thereafter, as seen in FIGS. 1 and 2, compression spring 23 causes forkbolt 21 to rotate clockwise to an unlatched position shown in FIG. 2. During this movement, striker pin 90 moves out of a rear portion 92 of throat 91, thus releasing striker pin 90.

In a like manner, when the door latch 10 is in an unlatched and unlocked condition, forkbolt 21 is poised to receive a striker pin 90 as shown in FIG. 2. When a door having latch 10 is shut, the striker pin 90 enters the throat 91 of forkbolt 21, engages the rear portion 92 of throat 91 and rotates forkbolt 21 counterclockwise against the bias of compression spring 23 until forkbolt 21 is rotated to the primary latched position shown in FIG. 1 and FIG. 3 where forkbolt 21 captures striker pin 90 in throat 91. Forkbolt 21 is held in the latched position by catch 94 of detent 22 engaging primary latch shoulder 36 of forkbolt 21.

As forkbolt 21 rotates counterclockwise from the unlatched position of FIGS. 2 and 4 to the primary latch position of FIGS. 1 and 3, catch 94 rides along the periphery of the forkbolt 21 under the full bias of detent spring 80. During this travel, catch 94 of detent 22 rides on the foot 40 to the edge 41 of foot 40 and then snaps into engagement with an intermediate secondary latch shoulder 38. If the door is shut solidly, catch 94 continues—riding up a ramp 43 to an edge 45 and then snaps into engagement with the primary latch shoulder 36.

During the latching movement described above, movement of detent 22 is causing the lateral pin 34 to ride within housing slot 42 along the travel path 46. The outer circumferential surface 35 of pin 34 slides along the first finger 81 from second portion 88, adjacent the end 89 of first finger 81 toward first portion 87 adjacent central helical portion 83.

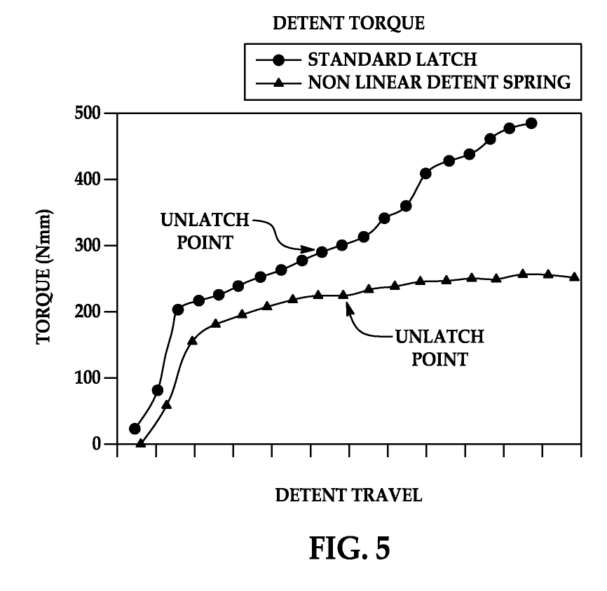

Referring now to the chart of FIG. 5, which shows a typical application of the invention, the detent torque applied to the detent 22 by detent spring 80 varies relative to the position of detent 22 along travel path 46. Specifically, a standard detent spring curve is shown. As can be seen, the torque required to unlatch the forkbolt 21, as applied at the unlatching lever 52, generally increase as a function of spring deformation. After a certain initial torque, spring torque increases linearly.

However, when using the detent spring of the present invention, as shown and described herein, the torque required to unlatch the forkbolt 21, as applied at the unlatching lever 23, is non-linear. The ability of lateral pin 34 to ride along first finger 81 of detent spring 80 causes the unlatching force vector at detent spring 80 to change direction as detent lever 22 moves along travel path 46. This change in direction allows the torque shown in FIG. 5 to non-linearly vary as a function of detent travel. The torque slope function shown flattens as detent travel increases during unlatching. Thus, after an initial torque is placed by an operator to unlatch door lock 10, the force required need not increase, as it would in a standard latch. Instead, the force required to operate door latch 10 is significantly less. As shown in FIG. 5, the torque required is one-third less than a standard door latch at the unlatch point, i.e. 300 Newton millimeters required by a standard door latch and 200 Newton millimeters required when using the present invention.

It will be appreciated that variations of the disclosed embodiment are contemplated. For instance a non-linear torque may be applied to detent lever 22 in ways different than shown. For instance, different detent springs 80 may be used other than the torsion spring shown. In addition, a non-linear torque may be applied to a standard compression spring by modifying detent lever 22 to rotate as a cam.

While the invention has been described in detail in connection with only a limited number of embodiments, it should be readily understood that the invention is not limited to such disclosed embodiments. Rather, the invention can be modified to incorporate any number variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

Having thus described the invention, it is claimed:

1. A door latch comprising:
a forkbolt that has a movement between a latched position and an unlatched position;
a detent that has movement on a travel path between a first position and a second position, said detent engaging and holding said forkbolt in said latched position when said detent is in said first position, said detent releasing the forkbolt for movement to said unlatched position when said detent is in said second position;
a detent spring eccentrically engaging said detent relative to said detent travel path and biasing the detent toward the first position; and
a release mechanism for moving the detent against the bias of the detent spring to said second position to release the forkbolt and produce a non-linear torque on said detent.

2. The door latch of claim 1, wherein said detent spring is a torsion spring.

3. The door latch of claim 1, wherein said detent is releasably attached to a pin, said detent spring eccentrically engaging said pin.

4. The door latch of claim 3, wherein said pin is rotatable relative to said detent and moves along said travel path.

5. The door latch of claim 3, wherein said pin is attached to an intermittent lever of said release mechanism.

6. The door latch of claim 5, wherein said release mechanism further includes an unlatching lever, said intermittent lever pivotably engaging said unlatching lever.

7. The door latch of claim 6, wherein said intermittent lever includes a first lever pivot for pivotably engaging said unlatching lever in a slot located within said unlatching lever.

8. The door latch of claim 1, including a first stud, said detent adapted to rotate about said first stud.

9. The door latch of claim 8, wherein said unlatching lever is adapted to rotate about said first stud.

10. The door latch of claim 1, including a second stud, said forkbolt adapted to rotate about said second stud.

11. A door latch comprising:
a forkbolt that has a movement between a latched position and an unlatched position;
a detent that has movement along a travel path between a first position and a second position, said detent engaging and holding said forkbolt in said latched position when said detent is in said first position, said detent releasing said forkbolt for movement to said unlatched position when said detent is in said second position;
a detent spring biasing said detent toward said first position;
an unlatching lever pivotably engaging said detent for moving said detent against the bias of said detent spring to said second position to release the forkbolt, said detent spring eccentrically engaging said detent relative to said travel path.

12. The door latch of claim 11, wherein said detent is releasably attached to a pin, said detent spring eccentrically engaging said pin.

13. The door latch of claim 11, including an intermittent lever interposed between said unlatching lever and said detent.

14. The door latch of claim 13, wherein said intermittent lever includes a pin extending therefrom, said pin releasably attached to said detent.

15. The door latch of claim 11, wherein said detent spring is a torsion spring having a first leg, a second leg and a helical portion there between.

16. The door latch of claim 15, wherein said detent engages said first leg at a first portion of said first leg adjacent said helical portion in said first position and said detent engages said first leg at a second portion opposite said helical portion in said second position.

17. The door latch of claim 16, wherein said detent is releasably attached to a pin, said first leg engaging said pin.
